(19) United States
(12) Patent Application Publication
(10) Pub. No.: US 2013/0253923 A1
(43) Pub. Date: Sep. 26, 2013

(54) MULTICHANNEL ENHANCEMENT SYSTEM FOR PRESERVING SPATIAL CUES

(71) Applicants: Frederic Mustiere, Ottawa (CA); Martin Bouchard, Gatineau (CA); Hossein Najaf-Zadeh, Stittsvile (CA); Louis Thibault, Gatineau (CA); Raman Pishehvar, Ottawa (CA); Hassan Lahdili, Gatineau (CA)

(72) Inventors: Frederic Mustiere, Ottawa (CA); Martin Bouchard, Gatineau (CA); Hossein Najaf-Zadeh, Stittsvile (CA); Louis Thibault, Gatineau (CA); Raman Pishehvar, Ottawa (CA); Hassan Lahdili, Gatineau (CA)

(73) Assignee: Her Majesty the Queen in Right of Canada, as represented by the Minister of Industry, Ottawa (CA)

(21) Appl. No.: 13/426,217

(22) Filed: Mar. 21, 2012

(51) Int. Cl. G10L 21/02; G10L 19/14

(52) U.S. Cl. 704/225; 704/E19.039; 704/E21.002

(57) ABSTRACT

A method is disclosed for maintaining spatial queues in digital sound signals. Sound signals are received from each of a plurality of transducers. The sound signals are transformed using a common real-valued spectral gain, G, to maintain spatial cues within the sound signals, the common spectral gain, G, determined by: calculating G as a function of a derivative of a known cost function and as a function of at least one multichannel frequency-domain Bayesian short-time estimator.

### FIELD OF THE INVENTION

The present invention generally relates to noise reduction in multi-sensor speech recordings, and more particularly to preserving spatial cues in noise reduced multi-sensor speech recordings.

### BACKGROUND

There is a known problem of preserving spatial cues—inter-channel time and level differences—in various multichannel frequency-domain noise reduction algorithms. In applications such as hearing aid devices, field recordings, or multichannel teleconferencing, it can be crucial to preserve such spatial impressions before reproducing an enhanced signal with multiple speakers. Unfortunately, many frequency-domain noise reduction algorithms operate independent of these cues and, as such, cues preservation is not a straightforward task. To preserve cues when relying on frequency-domain noise reduction algorithms, a possible strategy is to aim for a single, real-valued frequency-dependent gain that is applied to all incoming samples. When this is done, interchannel time and amplitude differences are preserved, phase response is zero, group delay is zero, and no dispersion is introduced.

Presently, it is known to estimate a real-valued frequency-dependent gain and then to apply the estimate to a system, but the gain estimation is based on arbitrary choices or successive approximations. Such estimation methodologies are well understood; unfortunately, while the resulting estimated real-valued frequency-dependent gain does preserves spatial cues, the sub-optimality of the gain estimation negatively affects the underlying noise reduction method. Therefore, a better method of spatial queue preservation is needed that is compatible with common present day signal processing methodologies.

It would be advantageous to overcome at least some of the drawbacks of the prior art.

### SUMMARY OF EMBODIMENTS OF THE INVENTION

In accordance with an embodiment of the invention there is provided a method comprising: receiving sound signals from each of a plurality of transducers; and, transforming the sound using a common real-valued spectral gain, G, to maintain spatial cues within the sound, the common spectral gain, G, determined by: calculating G as a function of a derivative of a known cost function and as a function of at least one multichannel frequency-domain Bayesian short-time estimator.

In accordance with an embodiment of the invention there is provided a circuit comprising: an input port for receiving digital sound signals from each of a plurality of transducers; a time-frequency domain transform circuit for transforming the received digital sound signals into the frequency domain; a frequency dependent common gain circuit for determining a frequency dependent common gain based on a function of a derivative of a known cost function and as a function of at least one multichannel Bayesian short-time estimator and for applying the frequency dependent common gain to each of the received digital sound signals within the frequency domain to produce enhanced signals; and a frequency-time domain transform circuit for transforming the enhanced signals into the time domain for providing a plurality of time domain output signals.

In accordance with an embodiment of the invention there is provided a method comprising: (a) capturing an audio signal with M microphones to obtain M input signals, wherein M is an integer greater than 1; (b) computing the speech spectral component estimate corresponding to the chosen spectral distance criterion based on the M input signals; (c) using the speech spectral component estimate of (a) to calculate the single real-valued frequency-dependent and time-varying gain that minimizes the spectral distance criterion; and (d) multiplying each of the M input signals by the real-valued frequency-dependent and time-varying gain within the frequency domain.

In accordance with an embodiment of the invention there is provided a method comprising: (a) providing M input signals, wherein M is an integer greater than 1; (b) computing the speech spectral component estimate corresponding to the chosen spectral distance criterion based on the M input signals; (c) using the speech spectral component estimate of (a) to calculate the single real-valued frequency-dependent and time-varying gain that minimizes the spectral distance criterion; (d) multiplying each of the M input signals by the real-valued frequency-dependent and time-varying gain within the frequency domain to produce M enhanced signals; and (e) sounding at least 2 of the M enhanced signals using sounding devices.

### BRIEF DESCRIPTION OF THE DRAWINGS

The invention will be described in greater detail with reference to the accompanying drawings which represent preferred embodiments thereof, in which like elements are indicated with like reference numerals, and wherein:

FIG. 1 is a simplified block diagram depicting a prior art stereo recording method;

FIG. 2 is a simplified block diagram depicting a typical setup for use in explaining embodiments of the present invention;

FIG. 3 is a simplified flow diagram depicting a method according to an embodiment the present invention.

FIG. 4 is a simplified flow diagram of a method according to an embodiment of the present invention.

FIG. 5 is a block diagram of a system according to an embodiment of the present invention.

FIG. 6 is a simplified flow diagram of a method according to an embodiment of the present invention.

### DETAILED DESCRIPTION OF EMBODIMENTS OF THE INVENTION

In the specification and in the claims that follow, the following terms are used as described below:

“single-channel recording” or a “single-channel signal” is a digital signal sampled at regular intervals, representing a physical sound that can be reproduced using a digital-to-analog converter and an appropriate speaker. Note that a single-channel signal may in fact be itself a mixture of various audio signals;

“multichannel recording” or a “multichannel signal” is a set of M (M>1) single-channel signals. In this invention, the input multichannel signal is assumed to be obtained from sampling at regular time intervals the analog signals measured at M microphones placed at distinct locations;

“Target speech signal” within a multichannel recording or “Clean speech signal” is the particular speech signal of interest in a multichannel recording for enhancement;

“noise signal” in a multichannel recording refers to all of the audio sources in a multichannel recording that are not the target speech signal;

“multichannel speech enhancement system” or “multichannel noise reduction system” refers to a system that comprises more than one microphone recording simultaneously a certain audio scene and whose goal is to reduce a level of noise signal within the multichannel signal;

“single-channel speech spectral component estimate” or “single-channel speech estimate,” or “single-channel estimate” refers to an estimate for a target speech spectral component that is only based on the noisy measurements obtained at one single microphone or sensor.

“single-channel estimator” is a process that produces a single-channel estimate;

“multichannel speech spectral component estimate,” “multichannel speech estimate,” or “multichannel estimate” refers to an estimate for a target speech spectral component that utilizes a full set of noisy measurements obtained at the available microphones or sensors;

“multi-channel estimator” is a process that produces a multichannel estimate;

“output signal” refers to a signal processed by the multichannel speech enhancement system which is assumed to be played for representing an input sound and spatial cues.

In a multichannel speech enhancement system whose goal is to produce a multichannel output signal, the multichannel output signal may be formed from single-channel estimates or from multichannel estimates. Theoretically and practically, it has been extensively shown in the literature that given the increased amount of information available, a higher quality output signal is obtainable by using multichannel estimates as opposed to single-channel estimates.

Recently, multichannel Bayesian (statistical-based) frequency-domain algorithms such as the multichannel Minimum-Mean-Squared-Error (MMSE) Short-Time-Spectral-Amplitude (STSA) estimator have been shown to perform very well. However, for most of these methods, the literature does not contain real-valued common gain expressions—and for the few specific subcases that it does, the expressions are heuristic and/or approximated and/or derived without being based on well-defined criteria. Herein and in the claims that follow, a “well-defined criterion” to obtain the gain refers to “a certain objective/cost function involving the gain as a variable, and which is to be optimized.” For example, the cost function may be some distance between the expected clean speech spectral component and the product of the gain with the noisy spectral component. With the freedom to choose a cost function, design of a speech enhancement system is more controlled and flexible.

Some known techniques rely upon an output value of a Minimum Variance Distortionless Response (MVDR) Beamformer to form a single real-valued common gain. However, the derivation of the gain is based on discretionary choices without clear and well-defined objectives, and the derivation is restricted to the MVDR Beamformer. It is also proposed to use heuristic rules to combine two single-channel MMSE-STSA estimates in order to obtain a single real-valued common gain, again without well-defined effects and objectives. Unfortunately, neither of these methods produce an optimal result or even a result with predictable quality measures.

Finally, it is known to rely on a well-defined objective and via a series of approximations, to form a combination of single-channel MMSE STSA estimates, which do not fully utilize all the available information. Once again, the results lack predictable quality measures and the successive approximations have a negative impact on the output quality.

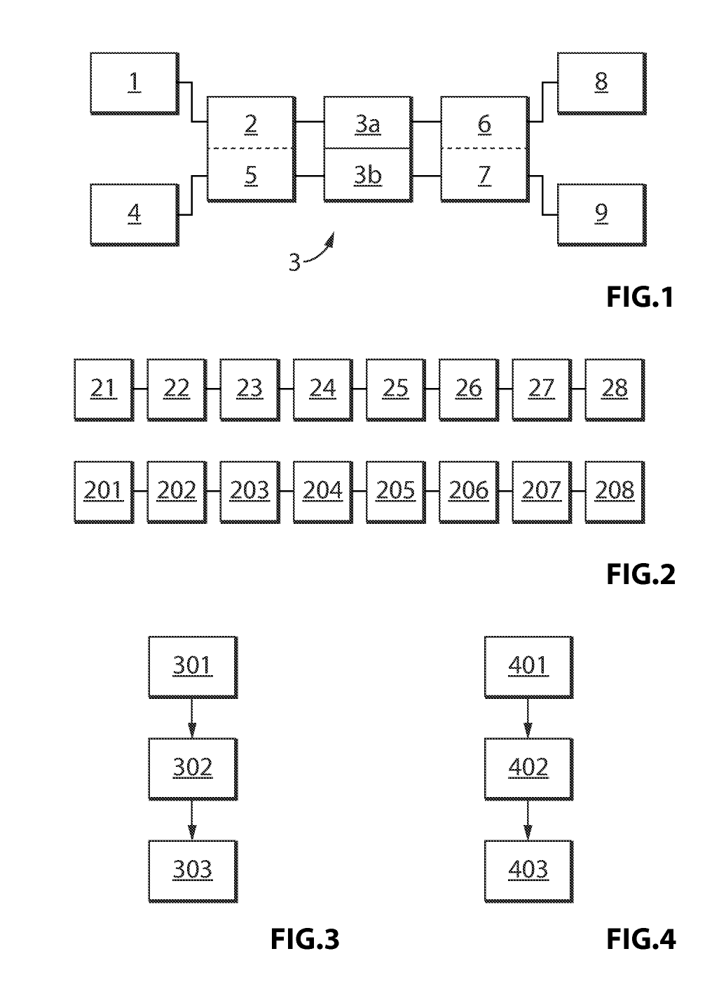

Referring to FIG. 1, shown in a simplified block diagram of a prior art system for multichannel speech capture and processing. A first microphone 1 is coupled to a first circuit 2 for recording first sounds on storage medium 3 within track 3a. A second microphone 4 is coupled to a second circuit 5 for recording second sounds on storage medium 3 within track 3b. Here, both sounds are independently recorded on the storage medium 3. It is well known that given known locations of the microphones 1 and 4 and spatial placement of speakers 8 and 9 driven by amplifiers 6 and 7, respectively, that such an analog system maintains spatial queues within the recorded sound. This forms a basis for most stereoscopic audio recordings.

When sound is processed in the digital domain, the overall system tends to appear more similar to the block diagram of FIG. 2. Here a first microphone 21 is for receiving a first sound signal and providing same to a conditioning circuit 22 such as a filter and then to a digitizing circuit 23 for analog to digital conversion. In the digital domain, the digital signal is processed by converting same to a frequency domain in block 24, adjusting frequency components thereof in frequency domain conditioning circuit 25 and converting the signal back to the time domain using, for example, a reverse transform in block 26. In the storage medium 27, the signal is stored or, alternatively, the signal is transmitted for being processed. Then the signal is provided to a sounding device 28. An analogous circuit exists for the second microphone 201 and for any further microphones. Here the second microphone 201 is for receiving a first sound signal and providing same to a second conditioning circuit 202 such as a second filter and then to a second digitizing circuit 203 for analog to digital conversion. In the digital domain, the digital signal is processed by converting same to a frequency domain at 204, adjusting frequency components thereof in second frequency domain conditioning circuit 205 and converting the signal back to the time domain using, for example, a reverse transform in block 206. In storage medium 207, the signal is stored or alternatively the signal is transmitted for being processed. Then the signal is provided to a sounding device 208.

As noted above, within the digital domain, the signal is transformed into the frequency domain for speech enhancement. Typically, the noise-reduction procedure involves applying a frequency dependent gain to the signal in order to enhance a speech component of the signal relative to non-speech components such as, for example, noise. Unfortunately, when each signal undergoes independent speech enhancement, the resulting signals lose spatial cues since the effective gain applied to each channel is different. As such, the resulting multi-channel signal is often not adequate for spatial cue reconstruction. Thus, it has been proposed to use a common gain to preserve spatial cues. The theory is that with a common variable gain, the system will maintain the spatial cues relative one to another. However, though this will preserve spatial cues, the gain must still be chosen appropriately so as to retain control of its overall effect in terms of noise reduction, i.e., so as to maintain the best possible overall noise reduction in the resulting multichannel signal.

Thus, a variable gain that is common to all signals needs determination, that is, the variable gain selected both for preserving spatial cues within the multichannel signal, but also for performing the required noise reduction. In a first embodiment well-defined multichannel objectives are provided by system designers, allowing them to have direct awareness of the noise reduction properties of the common gain sought. Moreover, in some embodiments a solution of multichannel objectives are then shown to depend on multichannel estimates that are themselves of significantly higher quality than either MVDR beamformers or single-channel MMSE-STSA estimators.

Referring to FIG. 3, shown is a simplified flow diagram of a method for use with embodiments of the invention. These embodiments comprise a multichannel speech enhancement system, taking M input audio signals acquired from microphones in distinct locations, and producing an output signal with spatial cues preserved. A well-defined objective is set out at 301 as are transfer functions for each transducer of a plurality of transducers at 302. For example, the transducers in the form of microphones are installed in a boardroom and spatial and auditory characteristics are determined therefrom. These characteristics are used to define transfer functions and a well-defined objective. The resulting well-defined objective and transfer functions are used at 303 to determine a frequency dependent variable gain function that is common across different captured audio signals for preserving spatial cues in the overall captured auditory data.

To obtain a real-valued common gain, a multichannel speech enhancement system is defined from multichannel estimates using well-defined multichannel objectives or criteria. The real-valued common gain expressions supported depend on a cost function and on assumptions regarding the statistical nature of the speech and noise signals. Typically, in most conditions even estimated transfer functions result in a usable real-valued common gain expressions.

The present embodiment is applicable in practical setups where multiple microphone signals are acquired and processed in order to extract a speaker location along a known Direction-Of-Arrival (DOA), and for which the ratio of the DOA-dependent transfer functions from the target speaker to each sensor is known. In certain situations, the DOA is estimable accurately, for example when the noise is assumed to be diffuse. Often, some contexts rely on an assumption that the target is “frontal”, i.e., located directly in front of the array, in which case no DOA estimation is performed; this may be the case for hearing aid applications for instance. In addition, the ratio of transfer functions is sometimes unavailable, in which case the ratio is optionally estimated, approximated, or based on a sensible model.

Once a strategy to determine the target DOA is established, a multichannel criterion/cost function is chosen and the corresponding solution is determined. In doing so, the form of the real-valued frequency-dependent gain to be applied to the noisy measurements is determined. The form of the corresponding common gain determines which multichannel frequency-domain estimator is calculated based on the incoming noisy signals. As explained above, in prior art, this step is either approximated, based on discretionary rules, or based on single-channel estimators followed by heuristic rules; as a result, in the prior art both the flexibility in the system design and the performance of the overall system are degraded.

Once the frequency-domain estimator is calculated, it is in turn used to compute the common gain, which is finally applied to all measurements in the frequency domain. Reverting to the time domain, the signals are stored or sent through the output sounding devices. In general, frequency-domain estimators rely on an estimate for the variance of the speech spectral component. Various methods exist and a form of multichannel Maximum-Likelihood estimator is used in the present embodiment.

With reference to FIG. 4, the overall system design of an embodiment will be explained. Prior to any operation, as stated above, a multichannel criterion to obtain the real-valued common gain is provided at 401 to define the type of enhancement that takes place in the overall system. In order to better describe this step, some notation is explained. At a given discrete time instant, assume all of the M frames corresponding to the M input signals over a given observation interval have been transformed into the frequency domain, resulting in a set of M complex-valued vectors, each containing K frequency bins (i.e., the size of the discrete Fourier transform is K). Denote by Z₁(k), Z₂(k), Z₃(k), . . . Z_{M}(k) the k^{th} noisy/measured spectral components. The frequency bin index k is not used in notation because it is assumed that all frequency bins are treated analogously. Further when m is an index for channels 1 to M and assuming an additive noise model, the following results:

Zₘ=HₘS+Nₘ

where Nₘ represents the noise spectral component, S represents the fully coherent part of the target speech, and Hₘ represents the transfer function between the target speech and the microphone m. With the above model, undesired components in the measurements such as late reverberating components, acoustic diffuse noise, sensor noise, etc., are included in the Nₘ components. Alternatively, without changing the notation, the above is viewable differently, with all Hₘ representing frequency ratios between all components and an arbitrary chosen “anchor”-channel j, in which case Hⱼ=1 and the signal to estimate is the speech received at channel j. In the following, A=|S| is a magnitude of the target speech component and below is denoted by Sₘ the quantities (Hₘ.S) and by z the collection {Z₁, Z₂, Z₃, . . . , Z_{M}}

Based on the above notation, multichannel criteria are of the form of a distance E between a function of the target speech spectral component S and a function of the measurements on which a real-valued gain G has been applied, conditioned on the knowledge of z. The main variable in this distance is G, and the optimal value of G that minimizes the distance E(G) is preferred. In the context of speech and signal processing, examples of distances include but are not limited to:

E(G)=ΣₘE{(|Sₘ|−G|Zₘ|)²|z}

E(G)=ΣₘE{(log |Sₘ|−log G|Zₘ|)²|z}

E(G)=ΣₘE{|Sₘ|²/(G|Zₘ|²)−log(|Sₘ|²/(G|Zₘ|²))−1|z}

E(G)=ΣₘE{(|Sₘ−GZₘ|)²|z}

E(G)=ΣₘE{(|Sₘ|²−G|Zₘ|²)²|z}

E(G)=ΣₘE{|Sₘ|/(G|Zₘ|)+G|Zₘ|/|Sₘ∥z}

E(G)=ΣₘE{|Sₘ|²/(G|Zₘ|²)+G|Zₘ|²/|Sₘ|²|z}

where E{ } is the statistical expectation operator, and the single | at the end of the expression indicates statistical conditioning. One can choose which cost function is appropriate depending on the application, the bandwidth of the signal, etc. For example, the above criteria include a discrete version of the Itakura-Saito distance, which is sometimes appealing as it is often used as a measure of the perceptual difference between two processes represented by their spectra. Further, selection between cost functions is possible based on experimentation and/or analysis of a particular configuration and application.

In the above cases, setting the derivative of E(G) with respect to G to 0 at 402 yields an equation that can be solved for G. In the resulting expressions for G, there appears probabilistic conditional estimators—at least one multichannel Bayesian short-time estimator—for example of the form E(A|z), E(log A|z), or E(A²|z). To compute these terms, a statistical model for the speech and noise spectral components is defined at 403; in the vast majority of cases in the literature, the speech and noise components are defined as independent, identically distributed Gaussian but more general settings, for example Generalized Gamma distributed speech components and mixture-of-Gaussians noise statistics, are also contemplated.

It now clearly appears that if the optimal gain expression exhibits certain specific multichannel estimators, then these should be used to maintain the optimality of the gain. However, any algorithm that is able to produce an estimate A′ for A could in fact be used for the determination of a common gain, most often with good results though they are suboptimal. For example, if E(A²|z) appears in a certain common gain expression, then this term is optionally replaced with A′². In other words, while these common gains are derived based on specific estimators, they may be used in conjunction with other estimators.

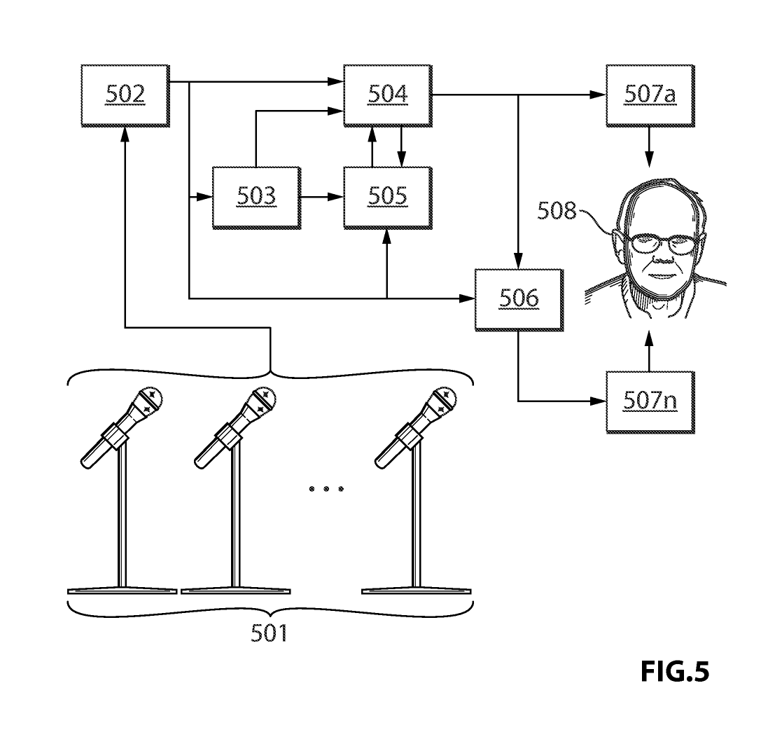

Referring to FIG. 5, a block diagram of a system according to an embodiment of the invention is presented. Microphones 501 capture sound signals and provide digital signals to a frequency transformation circuit in the form of FFT circuit 502. Within the frequency domain, noise statistics estimation is performed in block 503, speech spectral components are estimated in block 504, variance tracking is performed in block 505, and frequency dependent variable common gain is determined in 506 and applied to the frequency domain digital signals within the frequency domain. Blocks 507a . . . 507n then convert the signals from the frequency domain back into a time domain for provision to sounding devices 508.

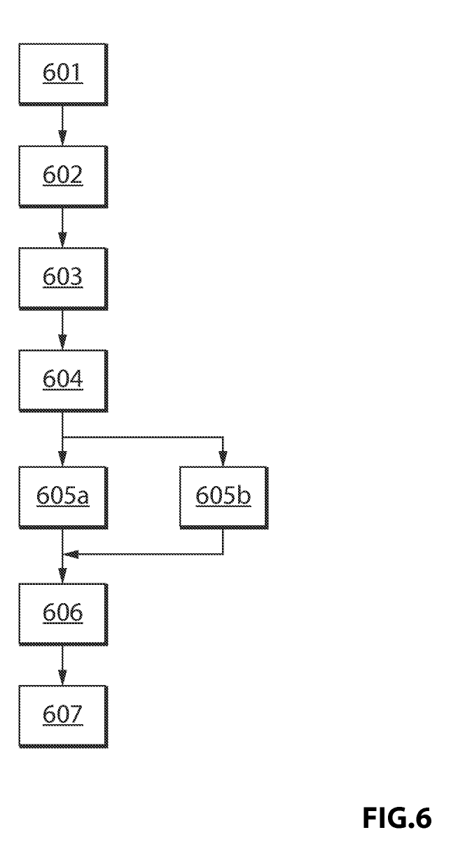

Focusing now on FIG. 6, M microphones are placed in distinct locations at 601 and captured signals are acquired digitally at 602. Alternatively the captured signals are digitized.
1) At 603, the captured M signals are decomposed into frames of fixed length. The frames are optionally windowed and further optionally overlapping—if so, the output signal reassembling block is appropriately matched as would be the case in a known technique of overlap-add reconstruction.
2) At 604, each frame is transformed to the frequency domain; for example, the standard technique—Fast Fourier Transformation (FFT)—is used.
3) At 605a and 605b, two blocks operate in parallel: Noise Statistics Estimation and the multichannel estimation of a speech spectral component are each performed. Many techniques exist for Noise Statistics Estimation such as voice-activity-detection, noise correlation matrix estimation, and null-beamforming. As previously explained, the multichannel speech estimator relies upon designer choice for common gain criterion.
4) At 606, based on the noise statistics and on a history of speech spectral components estimates, in most cases an estimate for the speech component variance is determined. Again, there exist various ways of determining this estimate, for example a multichannel Maximum-Likelihood estimate in the case of Gaussian noise and speech statistics.
5) At 607, the noisy spectral components and the speech spectral component estimate are provided to a “Common gain calculation and application” block. At an output port of the block, enhanced M signals are reverted to the time domain via Inverse Fast Fourier Transformation (IFFT) and frame overlapping/adding when necessary.

To compute the common gain, the M noisy spectral components and the speech spectral component estimate are used. The form of the solution depends on which cost function was chosen, and only needs to be determined once. The single gain is then multiplied by the M noisy spectral components, producing the enhanced signals to be reverted to the time domain.

The appearances of the phrase “in one embodiment” in various places in the specification are not necessarily all referring to the same embodiment, nor are separate or alternative embodiments mutually exclusive of other embodiments.

Numerous other embodiments may be envisaged without departing from the scope of the invention.

What is claimed is:

1. A method comprising:
receiving sound signals from each of a plurality of transducers; and
transforming the sound signals using a common real-valued spectral gain, G, to maintain spatial cues within the sound signals, the common spectral gain, G, determined by:
calculating G as a function of a derivative of a known cost function and as a function of at least one multichannel frequency-domain Bayesian short-time estimator.

2. A method according to claim 1 wherein the multichannel frequency-domain Bayesian short-time estimator is determined using a function of the clean speech spectral component with reference to z.

3. A method according to claim 2 wherein the multichannel frequency-domain Bayesian short-time estimator determined using a function of the clean speech spectral component with reference to z is a statistical expectation of a function of the complex clean speech spectral component with reference to z, E(f(S)|z).

4. A method according to claim 3 wherein the function of the statistical expectation of a function of the complex clean speech spectral component with reference to z is within a log scale.

5. A method according to claim 3 wherein the function of the statistical expectation of a function of the complex clean speech spectral component with reference to z is signed.

6. A method according to claim 3 wherein the function of the statistical expectation of a function of the complex clean speech spectral component with reference to z is scaled.

7. A method according to claim 3 wherein the function of the statistical expectation of a function of the complex clean speech spectral component with reference to z is non-linear.

8. A method according to claim 2 wherein the function of the clean speech spectral component with reference to z is an estimation of a higher order function comprising a term relating to an amplitude of the function of the clean speech spectral component with reference to z.

9. A method according to claim 2 wherein calculating G as a function of a derivative of a known cost function comprises:
providing the known cost function; and
determining a function for determining G based on equating a derivative of the known cost function to zero, the result expressed as a function of at least one multichannel Bayesian short-time estimator.

10. A method according to claim 1 comprising:
converting the sound signals from a time domain into a frequency domain, wherein transforming is performed within the frequency domain; and
converting the transformed frequency domain sound signals back to the time domain to provide an output signal.

11. A method according to claim 10 comprising:
receiving sound at a transducer circuit, the sound converted by the transducer circuit to digital values representative of the received sound.

12. A method according to claim 11 comprising:
providing the output signal to a plurality of sounding devices.

13. A method according to claim 11 comprising:
determining a direction of arrival of speech within the output signal.

14. A method according to claim 1 wherein each of the plurality of transducers consists of a plurality of microphones.

15. A circuit comprising:
an input port for receiving digital sound signals from each of a plurality of transducers;
a time-frequency domain transform circuit for transforming the received digital sound signals into the frequency domain;
a frequency dependent common gain circuit for determining a frequency dependent common gain based on a function of a derivative of a known cost function and as a function of at least one multichannel Bayesian short-time estimator and for applying the frequency dependent common gain to each of the received digital sound signals within the frequency domain to produce enhanced signals; and
a frequency-time domain transform circuit for transforming the enhanced signals into the time domain for providing a plurality of time domain output signals.

16. A circuit according to claim 15 forming part of a hearing aid.

17. A circuit according to claim 15 forming part of an audio conferencing system.

18. A circuit according to claim 15 comprising a plurality of microphones.

19. A circuit according to claim 15 comprising a plurality of sounding devices.

20. A circuit according to claim 15 comprising:
a noise statistics estimation circuit and a speech spectral component estimator, the noise statistics estimation circuit and the speech spectral component estimator operating on signals within the frequency domain.

21. A method comprising:
a) capturing an audio signal with M microphones to obtain M input signals, wherein M is an integer greater than 1;
b) computing a speech spectral component estimate corresponding to the chosen spectral distance criterion based on the M input signals;
c) using the speech spectral component estimate of b) to calculate the single real-valued frequency-dependent and time-varying gain that minimizes the spectral distance criterion; and
d) multiplying each of the M input signals by the real-valued frequency-dependent gain and time-varying gain within the frequency domain.

22. The method of claim 21, wherein computing the speech spectral component estimate comprises:
a) estimating a target speech spectral component variance;
b) obtaining noise spectral component estimates from the M input signals; and,
c) using a target speech component variance and a noise spectral component estimates to obtain the speech spectral component estimate.

23. A method comprising:
a) providing M input signals, wherein M is an integer greater than 1;
b) computing a speech spectral component estimate corresponding to the chosen spectral distance criterion based on the M input signals;
c) using the speech spectral component estimate of b) to calculate the single real-valued frequency-dependent and time-varying gain that minimizes the spectral distance criterion;
d) multiplying each of the M input signals by the real-valued frequency-dependent gain and time-varying gain within the frequency domain to produce M enhanced signals; and
e) sounding at least 2 of the M enhanced signals using sounding devices.

24. The method of claim 23, wherein computing the speech spectral component estimate comprises:
a) estimating a target speech spectral component variance;
b) obtaining noise spectral component estimates from the M input signals; and
c) using a target speech component variance and a noise spectral component estimates to obtain the speech spectral component estimate.
